(19) United States
(12) Patent Application Publication
(10) Pub. No.: US 2014/0132060 A1
(43) Pub. Date: May 15, 2014

(54) Bicycle Wheel Rim

(71) Applicant: ALEX GLOBAL TECHNOLOGY, INC., Tainan City (TW)

(72) Inventor: Chao-Ying CHEN, Tainan City (TW)

(73) Assignee: ALEX GLOBAL TECHNOLOGY, INC., Tainan City (TW)

(21) Appl. No.: 13/757,126

(22) Filed: Feb. 1, 2013

(30) Foreign Application Priority Data
Nov. 15, 2012 (TW) 101142628

(51) Int. Cl. B60B 21/10

(52) U.S. Cl. CPC B60B 21/104
USPC 301/95.104

(57) ABSTRACT

A bicycle wheel rim adapted for mounting with a pair of tire rim portions of a tire includes a base portion and a pair of annular flanges. The base portion has an inner ring wall, and an outer ring wall surrounding the inner ring wall. Each annular flange has an inclined inner surface adapted for abutting against a corresponding one of the tire rim portions. The outer ring wall is disposed between the annular flanges, and includes a pair of connection sections, each of which is connected to a corresponding one of the annular flanges and has a retaining surface that cooperates with the inclined inner surface of the corresponding annular flange to form an included angle smaller than 90 degrees.

### CROSS-REFERENCE TO RELATED APPLICATION

This application claims priority to Taiwanese Application No. 101142628, filed on Nov. 15, 2012.

### BACKGROUND OF THE INVENTION

1. Field of the Invention

The invention relates to a bicycle wheel rim, more particularly to a bicycle wheel rim formed with an included angle smaller than 90 degrees for mounting a tire.

2. Description of the Related Art

Generally, a bicycle wheel rim is designed to have either a single-layer structure or a two-layer structure. FIG. 1 shows the two-layer structure of a conventional bicycle wheel rim 1 that is adapted for mounting a tire 10 thereon. The tire 10 has a pair of annular tire rim portions 101 that are spaced apart from each other in a left-right direction. The conventional bicycle wheel rim 1 includes a pair of annular flanges 11 that are symmetric in the left-right direction, and an annular base portion 12 interconnecting the annular flanges 11. The base portion 12 has an inner ring wall 121 surrounding a rotation axis of the conventional bicycle wheel rim 1, and an outer ring wall 122 surrounding an outer circumference of the inner ring wall 121. The inner ring wall 121 is adapted for mounting a plurality of wheel spokes thereon (not shown). The outer ring wall 122 includes a pair of connection sections 123, each of which is connected to a corresponding one of the annular flanges 11.

Each of the annular flanges 11 has a parallel section 111 that is connected to the base portion 12 and that extends parallel to a central radial plane 13 of the conventional bicycle wheel rim 1, and a curved section 112 that extends outwardly and radially from an outermost end of the parallel section 111 distal from the base portion 12 and that is arcuately bent toward the central radial plane 13. The curved section 112 has a thickness that is substantially equal to that of the parallel section 111. The parallel section 111 has an inner upright surface 113 that extends parallel to the central radial plane 13, and a curved surface 114 interconnecting the inner upright surface 113 and a corresponding one of the connection sections 123.

During assembling, each of the tire rim portions 101 of the tire 10 abuts against the inner upright surface 113 and the curved surface 114 of a corresponding one of the annular flanges 11, so that the curved section 112 of the corresponding annular flange 11 is hookedly engaged with the corresponding tire rim portion 101 between the parallel section 111 and the corresponding connection section 123.

The conventional bicycle wheel rim 1 primarily relies on the curved sections 112 of the annular flanges for fastening the tire rim portions 101 of the tire 10 on the conventional wheel rim 1. After mounting the tire 10 on the conventional bicycle rim 1, since the inner upright surfaces 113 of the parallel sections 111 of the corresponding annular flanges 11 may be unable to abut against and to be engaged with the tire rim portions 101 of the tire 10, the force acted on the conventional bicycle wheel rim 1 by the tire 10 is primarily concentrated on the curved sections 112 of the annular flanges 11. Moreover, in order to reduce the weight of the conventional bicycle wheel rim 1, the thickness of the curved sections 112 of the annular flanges 11 tends to be reduced. Although the weight of the conventional bicycle wheel rim 1 can be decreased by such design, such decrease in thickness of the curved sections 112 will adversely affect a structural strength of the curved sections 112. Therefore, the structural strength of the curved sections 112 may not be sufficient to sustain concentrated stress resulted from the tire 10, and thus, the overall structural strength of the conventional bicycle wheel rim 1 may be insufficient.

### SUMMARY OF THE INVENTION

Therefore, an object of the present invention is to provide a bicycle wheel rim that can alleviate the aforesaid drawback of the prior art.

According to the present invention, a bicycle wheel rim is adapted for mounting a tire that has a pair of tire rim portions. The bicycle wheel rim includes abase portion and a pair of annular flanges.

The base portion has an inner ring wall surrounding a rotation axis of the bicycle wheel rim, and an outer ring wall surrounding an outer circumference of the inner ring wall.

The pair of annular flanges are disposed symmetrically and oppositely relative to a central radial plane perpendicular to the rotation axis. Each of the annular flanges has an inclined inner surface adapted for abutting against a corresponding one of the tire rim portions.

The outer ring wall is disposed between the annular flanges, and includes a pair of connection sections, each of which is connected to a corresponding one of the annular flanges and has a retaining surface that cooperates with the inclined inner surface of the corresponding one of the annular flanges to form an included angle smaller than 90 degrees.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary sectional view of a conventional bicycle wheel rim for mounting a tire;

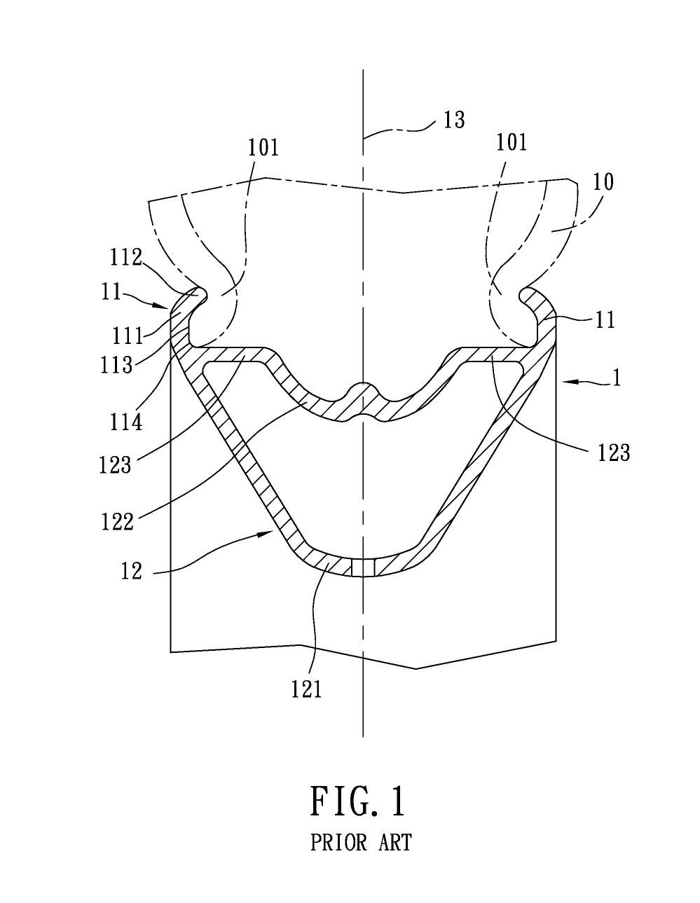

FIG. 2 is a fragmentary sectional view, illustrating the first preferred embodiment of a bicycle wheel rim according to the present invention;

FIG. 3 is an enlarged fragmentary sectional view of the first preferred embodiment;

FIG. 4 is an enlarged fragmentary sectional view, illustrating the second preferred embodiment of a bicycle wheel rim according to the present invention; and

FIG. 5 is an enlarged fragmentary sectional view, illustrating the third preferred embodiment of a bicycle wheel rim according to the present invention.

### DETAILED DESCRIPTION OF THE PREFERRED EMBODIMENTS

Before the present invention is described in greater detail, it should be noted that like elements are denoted by the same reference numerals throughout the disclosure.

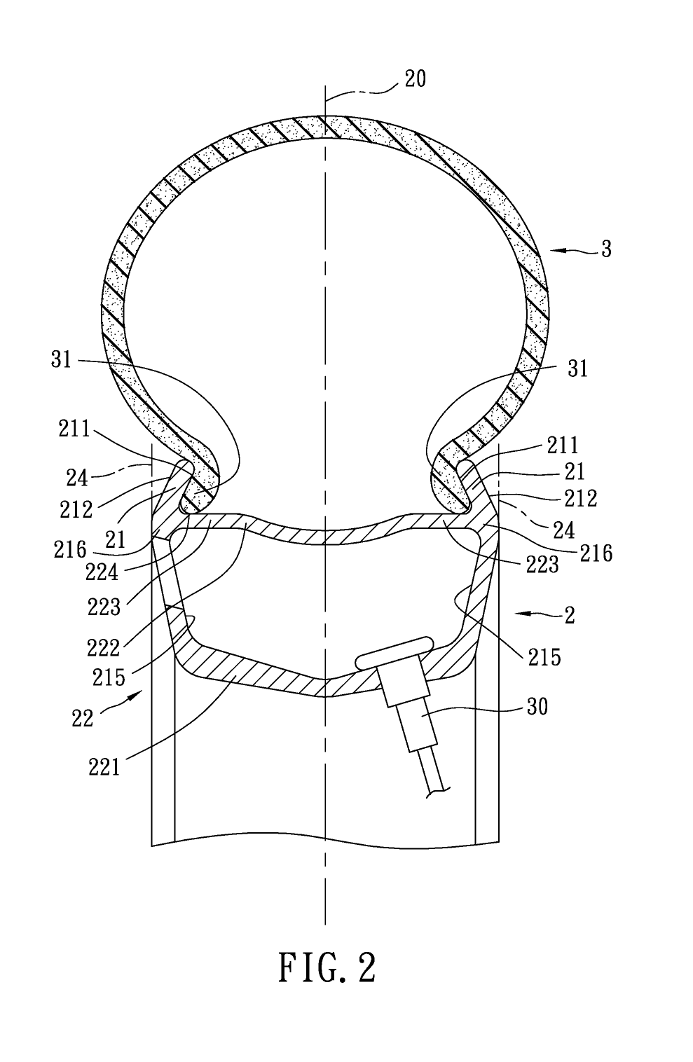

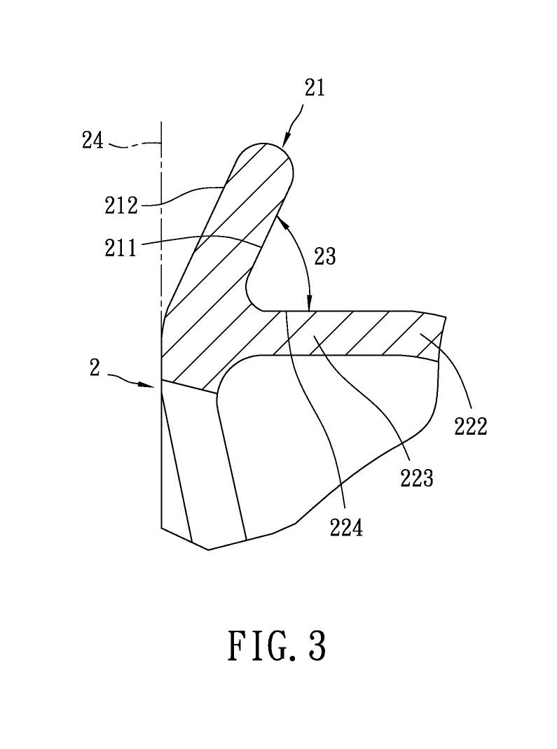

Referring to FIGS. 2 and 3, the first preferred embodiment of a bicycle wheel rim 2 adapted for mounting a tire 3 according to the present invention is shown. The tire 3 has a pair of tire rim portions 31 to be mounted on the bicycle wheel rim 2. The bicycle wheel rim 2 is adapted for mounting a plurality of wheel spokes 30 (only one is shown in FIG. 2). The bicycle wheel rim 2 includes a base portion 22 and a pair of annular flanges 21. The base portion 22 is a two-layer structure, and has an inner ring wall 221 surrounding a rotation axis of the bicycle wheel rim 2, and an outer ring wall 222 surrounding an outer circumference of the inner ring wall 221. The pair of annular flanges 21 are disposed symmetrically and oppositely relative to a central radial plane 20 perpendicular to the rotation axis of the bicycle wheel rim 2. In this preferred embodiment, the tire rim port ions 31 are symmetrically and oppositely disposed relative to the bicycle wheel rim 2. Each of the annular flanges 21 has an inclined inner surface 211 that is adapted for abutting against a corresponding one of the tire rim portions 31.

In this preferred embodiment, the inner ring wall 221 is adapted for assembling with the wheel spokes 30. The outer ring wall 222 is disposed between the annular flanges 21, and includes a pair of connection sections 223, each of which is connected to a corresponding one of the annular flanges 21 and has a retaining surface 224 that cooperates with the inclined inner surface 211 of the corresponding one of the annular flanges 21 to form an included angle 23 smaller than 90 degrees. Preferably, the included angle 23 is smaller than 90 degrees and larger than 60 degrees. Moreover, each of the retaining surfaces 224 of the connection sections 223 is perpendicular to the central radial plane 20 of the bicycle wheel rim 2.

Preferably, the base portion 22 further includes a pair of annular intermediate walls 215, which are disposed respectively on two opposite sides of the central radial plane 20 and each of which is connected between the inner and outer ring walls 221, 222 and extends outwardly from the inner ring wall 221 to the outer ring wall 222. The annular intermediate walls 215 have outermost projecting portions 216 proximate to the connection sections 223, respectively. Each of the annular flanges 21 is disposed between the central radial plane 20 and one of two imaginary planes 24 that are parallel to the central radial plane 20 and that respectively extend through the outermost projecting portions 216. In this preferred embodiment, since each of the annular flanges 21 is designed to be radially and outwardly inclined toward the central radial plane 20, each of the annular flanges 21 has an outer surface 212 disposed parallel to the corresponding one of the inclined inner surfaces 211.

When the tire 3 is mounted on the bicycle wheel rim 2, the tire rim portions 31 abut against the inclined inner surfaces 211, respectively. Due to the inclined design of the annular flanges 21, the inclined inner surfaces 211 are respectively abutted against the tire rim portions 31 to prevent the detachment of the tire portions 31 from the bicycle wheel rim 2.

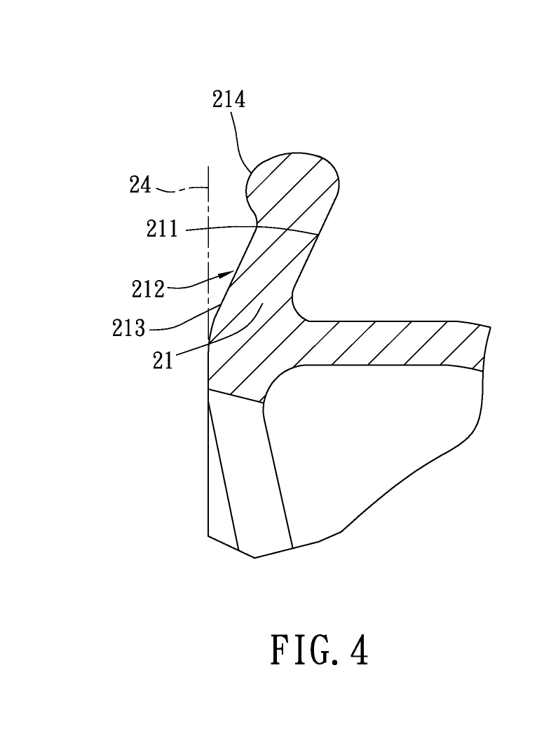

FIG. 4 shows the second preferred embodiment of a bicycle wheel rim 2 according to the present invention, which has a structure generally similar to that of the first preferred embodiment. However, in this embodiment, each of the annular flanges 21 has an outer surface 212 including an inclined section 213 that extends parallel to the inclined inner surface 211 and that has an inner end connected to the outer ring wall 222 and an outer end opposite to the inner end of the inclined section 213, and a protrusion 214 connected to the outer end of the inclined section 213. The protrusion 214 may be enlarged for increasing a structural strength of each annular flange 21. Preferably, the protrusion 214 of each annular flange 21 does not extend through a corresponding one of the imaginary planes 24.

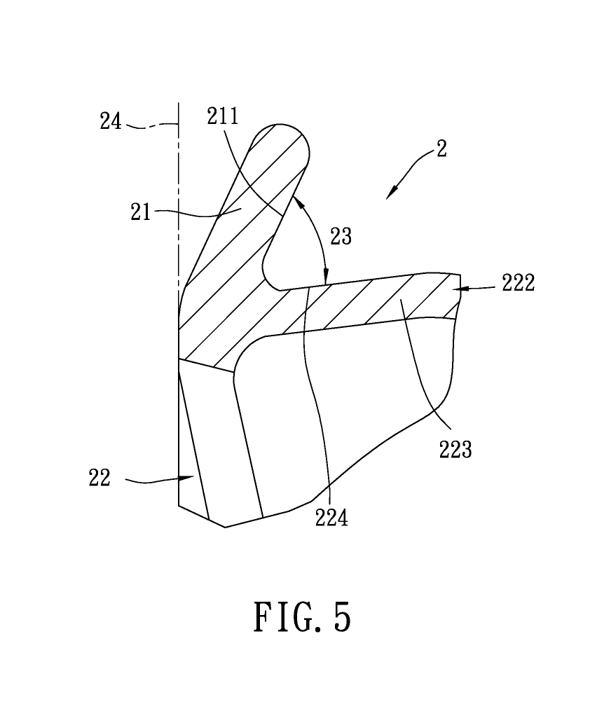

FIG. 5 shows the third preferred embodiment of a bicycle wheel rim 2 according to the present invention, which has a structure generally similar to that of the first preferred embodiment. However, in this preferred embodiment, each of the retaining surfaces 224 of the connection sections 223 extends toward the rotation axis from a corresponding one of the annular flanges 21 and is gradually inclined radially and outwardly with respect to the rotation axis, thereby reducing the included angle 23.

To sum up, by virtue of the inclined design of the annular flanges 21, the inclined inner surfaces 211 are able to abut against the tire rim portions 31 of the tire 3 and to prevent the detachment of the tire rim portions 31 from the bicycle wheel rim 2 . Moreover, when an external force is acted on the bicycle wheel rim 2, the annular flanges 21 are able to evenly endure the stress resulted from the external force, i.e., the problem of the stress concentrated between the tire rim portions 101 of the tire 10 and the annular flanges 11 of the conventional bicycle wheel rim 1 encountered in the prior art can be alleviated. That is to say, compared with the conventional bicycle wheel rim, the structure of the present invention has greater strength. On the other hand, by virtue of the inclined design of the annular flanges 21, the bicycle wheel rim 2 of the present invention not only has improved structural strength, but also has the annular flanges 21 with reduced thickness, thereby reducing the weight of the bicycle wheel rim 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A bicycle wheel rim adapted for mounting a tire that has a pair of tire rim portions, the bicycle wheel rim comprising:
abase portion having an inner ring wall surrounding a rotation axis of the bicycle wheel rim, and an outer ring wall surrounding an outer circumference of said inner ring wall; and
a pair of annular flanges disposed symmetrically and oppositely relative to a central radial plane perpendicular to the rotation axis, each of said annular flanges having an inclined inner surface adapted for abutting against a corresponding one of the tire rim portions;
said outer ring wall being disposed between said annular flanges, and including a pair of connection sections, each of which is connected to a corresponding one of said annular flanges and has a retaining surface that cooperates with said inclined inner surface of the corresponding one of said annular flanges to form an included angle smaller than 90 degrees.

2. The bicycle wheel rim as claimed in claim 1, wherein said included angle is larger than 60 degrees.

3. The bicycle wheel rim as claimed in claim 2, wherein each of said retaining surfaces of said connection sections is perpendicular to the central radial plane of the bicycle wheel rim.

4. The bicycle wheel rim as claimed in claim 2, wherein each of said retaining surfaces of said connection sections extends toward the rotation axis from a corresponding one of said annular flanges and is gradually inclined radially and outwardly with respect to the rotation axis.

5. The bicycle wheel rim as claimed in claim 2, wherein said base portion further includes a pair of annular intermediate walls, which are disposed respectively on two opposite sides of the central radial plane and each of which is connected between said inner and outer ring walls and extends outwardly from said inner ring wall to said outer ring wall, said annular intermediate walls having outermost projecting portions proximate to said connection sections, respectively, each of said annular flanges being disposed between the central radial plane and one of two imaginary planes that are parallel to the central radial plane and that respectively extend through said outermost projecting portions.

6. The bicycle wheel rim as claimed in claim 5, wherein each of said annular flanges has an outer surface disposed parallel to the corresponding one of said inclined inner surfaces.

7. The bicycle wheel rim as claimed in claim 5, wherein each of said annular flanges has an outer surface including an inclined section that extends parallel to said inclined inner surface and that has an inner end connected to said outer ring wall and an outer end opposite to said inner end of said inclined section, and a protrusion connected to said outer end of said inclined section.
